(19) United States
(12) Patent Application Publication
(10) Pub. No.: US 2005/0274425 A1
(43) Pub. Date: Dec. 15, 2005

(54) Flexiform tubing

(75) Inventors: James E. Ostrander, Rochester Hills, MI (US); Timothy J. Stuart, Lapeer, MI (US); Gary O. Klinger, Rochester Hills, MI (US); Christopher R. Terry, Leonard, MI (US)

Correspondence Address: YOUNG & BASILE, P.C., 3001 WEST BIG BEAVER ROAD, SUITE 624, TROY, MI, 48084, US

(73) Assignee: ITT Manufacturing Enterprises, Inc., Wilmington, DE (US)

(21) Appl. No.: 11/144,281

(22) Filed: Jun. 3, 2005

Related U.S. Application Data
(60) Provisional application No. 60/576,845, filed on Jun. 3, 2004.

(51) Int. Cl. F16L 9/14

(52) U.S. Cl. 138/144; 138/140; 138/141

(57) ABSTRACT

A conduit including at least one thermoplastic layer and a wire bondably embedded in the thermoplastic layer. The wire composed of a bendable material capable of maintaining the conduit in a bent configuration.

This application claims the benefit of the May 5, 2004 filing date of U.S. Provisional Application No. 60/576,845, filed Jun. 3, 2004, the contents of which are incorporated herein in their entirety.

### BACKGROUND

The present invention relates, in general, to flexible tubes and hoses that can be set in one or more bent configurations.

In many different applications, fluid carrying hoses or tubes must be bent into serpentine shapes for mounting in an engine compartment, vehicle underbody, etc. Typically, the tubes or hoses are shaped around one or more mandrels into the desired bent, serpentine configuration and then placed in an oven. A thermal source in the oven raises the temperature of the materials forming the hoses to set the hoses in the bent shape. However, the use of a thermal source adds cost to the formation of the hose.

In efforts to eliminate the use of thermal energy, hoses or tubes have been manufactured with one or more wires embedded into the typically plastic material forming the sidewall of the hose or in between one or more layers of a multilayer hose. The wire(s) can be manually bent into a desired shape and will retain the shape thereby enabling the hose to be bent into a desired serpentine configuration and remain in the serpentine configuration without the need for thermal energy required to set the plastic material forming the hose into the desired shape.

Such wires have assumed a generally linear configuration as well as being provided in spiral or helical and even braided, interwoven shapes within the hose wall.

Such assemblies have drawbacks with regard to integration of the wire(s) and polymeric layers into a unitary integral tubing construction. Typically unitary wires in linear or spiral configurations, as well as braids and interwoven shapes, slip or unduly bind relative to the surrounding polymeric material causing inferior performance. Thus, it is believed that improvements can still be made to the use of such hoses.

### DESCRIPTION OF THE DRAWINGS

The various features, advantages and other uses of the present invention will become more apparent by referring to the following detailed description and drawing in which:

FIG. 1 is a cross-sectional view of a flexiform tube according to one aspect of the present invention;

FIG. 2 is a partial perspective view of another aspect of a flexiform tube according to the present invention;

FIG. 3 is a perspective view of yet another aspect of a flexiform tube according to the present invention;

FIG. 4 is a side-elevational view of another aspect of a flexiform tube according to the present invention;

FIG. 5 is a cross-sectional view generally taken along line 5-5 in FIG. 4;

FIG. 6 is a side-elevational view of another aspect of a flexiform tube according to the present invention; and

FIG. 7 is a cross-sectional view of another aspect of a flexiform tube according to the present invention.

### DETAILED DESCRIPTION

Disclosed herein is a fluid conduit useful for conveying a variety of fluids including, but not limited to, automotive fuels, fluids, and vapors. The conduit includes at least one layer composed of at least one melt-processible thermoplastic material and at least one bendable wire bondably embedded therein. As used herein, the term “bendable” is taken to mean capable of deforming and maintaining the deformed position. The term “bondable” or bondably” as used herein is taken to mean capable of adhesion between the wire and the thermoplastic material proximate to the wire surface.

Without being bound to any theory, it is believed that integration of at least one bendable wire into the thermoplastic material layer such that the thermoplastic surrounding the wire achieves bonding between the wire and thermoplastic can contribute to a fluid conduit construction that can be bent to shape either manually or in suitable forming machines and maintain desired configuration in operative use without exhibiting undue layer to layer delamination or slippage between wire and thermoplastic material.

Referring now to the drawing, and to FIG. 1 in particular, there is depicted a fluid conduit 10 having one or more embedded wires, with three wires 12, 14 and 16 being illustrated by way of example only.

In the broadest sense of the disclosure herein, the one or more embedded wires 12, 14 and 16 are preferably formed of an easily bendable material such as a metal or metal alloy such as various ferrous and nonferrous metals and alloys. Nonlimiting examples include copper, aluminum, and alloys thereof such as brass, various irons and iron alloys such as low carbon steel, stainless steel, etc. It is also contemplated that the embedded wire may be composed in whole or in part of various materials such as shape memory alloys and the like, as desired or required. It is also contemplated that one or more of the wires 12, 14, 16 may be composed of materials capable of carrying or conveying electric current and/or information. Thus the various wires 12, 14, 16 may each be composed of different materials as desired or required. Where one or more wires 12, 14, 16 are configured to convey information or data, it is contemplated that the wire may include or be composed of suitable information, conveying material such as fiberoptic cable. The one or more wires 12, 14, 16 composed of a bendable material such as a metal or metal alloy can have a tensile strength between about 80 psi and about 180 psi as measured by ASTM Method A679/A679M-00 and analogous metal methods. The wires 12, 14, 16 can be of any thickness suitable for positioning in the wall of conduit 10. The wire thickness will be one that can support and maintain the suitable bend configuration.

The one or more wires 12, 14, and 16 may be embedded in a single wall thickness, homogeneous layer forming the fluid conduit 10. The fluid conduit 10 is composed of one or more plastic materials. The plastic material of choice will typically be composed of at least one thermoplastic polymer. The thermoplastic polymers suitable for use herein may be melt-processible materials. Nonlimiting examples of melt-processible thermoplastic materials include thermoplastic elastomers, polyolefins, thermoplastic polyesters, polyamides, polyphenylene sulfates, and the like.

Non-limiting examples of suitable thermoplastic elastomers include, but are not limited to, materials such as SANTOPRENE. SANTOPRENE, is commercially available from Advanced Elastomer Systems, L.P. of St. Louis, Mo. and is believed to be a thermoplastic rubber. Particular materials of interest are those considered to be bondable grades. Such materials may be advantageously employed in contact with the wires 12, 14, 16 etc. It is also contemplated that various extrusion grade formulations can employed in the conduit formulations as desired or required.

Aside from the thermoplastic rubber component, it is contemplated that the materials may contain various additives. These may include materials such as antimony trioxide flame retardant, and carbon black, CAS No. 1333-86-4. SANTOPRENE thermoplastic rubber may react with strong oxidizing chemicals, and also reacts with acetal resins at temperatures of 425° F. and above, producing decomposition of the acetal resins, and formaldehyde as a decomposition product. Decomposition of halogenated polymers and phenolic resins may also be accelerated when they are in contact with SANTOPRENE thermoplastic rubber at processing temperatures. Physical characteristics of SANTOPRENE include a slightly rubber-like odor, and the appearance of black or natural (colorable) pellets. It is typically thermally stable to 500° F. The flash ignition temperature is greater than 650° EF by method ASTM-D 1929-77, and by the same method, self-ignition temperature is above 700° F. The typical specific gravity is 0.90 to 1.28. The material has various hardnesses which are suitable in the present invention, however, in the preferred embodiment, the SANTOPRENE thermoplastic rubber having an 80 Shore A hardness is utilized. The SANTOPRENE thermoplastic rubber is designed to offer fluid and oil resistance equivalent to that of conventional thermoset rubbers such as neoprene. The resistance of the SANTOPRENE rubber grades to oils can be classified by using the SAE J200/ASTM D2000 standard classification system for rubber.

Examples of suitable polyamides include, but are not limited to, polyamides such as nylon-6, nylon-6,6, nylon-11, and nylon-12. as well as other nylon materials such as nylon-6,12; nylon-6,9; nylon-4; nylon-4,2; nylon-4,6; nylon-7; and nylon-8, nylon 6,10 and nylon 9 may be used, as well as ring-containing polyamides such as nylon-6,T and nylon-6,1 and various polyether-containing polyamides. Typically, nylons have been prepared in the past by the condensation of a dicarboxylic acid and a diamine. For example, nylon 66 is prepared by the condensation reaction of the six-carbon dicarboxylic acid, adipic acid and the six-carbon diamine, hexamethylenediamine. Nylon 6,10 is commonly prepared by the condensation reaction of sebasic acid, a 10-carbon dicarboxylic acid, and hexamethylenediamine. Other nylons such as nylon such as nylon 4, nylon 6 and nylon 9 are obtained by polymerization of butyrolactam, caprolactam and 9-aminononanoic acid, respectively. The polyamide material may include suitable additives to enhance bondability with the desired wires. It is also contemplated that the nylon may be combined with suitable materials such as bondable SANTOPRENE to enhance bondability.

Examples of suitable thermoplastic elastomers include, but are not limited to, acrylonitrile butadiene (NBR), butadiene rubber, chlorinated and chloro-sulfonated polyethylene, chloroprene, ethylene-propylene monomer (EPM) rubber, ethylene-propylene-diene monomer (EPDM) rubber, epichlorohydrin (ECO) rubber, polyisobutylene, polyisoprene, polysulfide, polyurethane, silicone rubber, blends of polyvinyl chloride and NBR, styrene butadiene (SBR) rubber, ethylene-acrylate copolymer rubber, and ethylene-vinyl acetate rubber. The thermoplastic elastomer may include suitable additives to achieve bondability and/or may be blended with suitable materials including, but not limited to, bondable SANTOPRENE to achieve bondability.

Examples of suitable melt-processible polyolefins include, but are not limited to homopolymers of ethylene, propylene, and the like, as well as copolymers of these monomers with, for example, acrylic monomers and other ethylenically unsaturated monomers such as vinyl acetate and higher alpha-olefins. Such polymers and copolymers can be prepared by conventional free radical polymerization or catalysis of such ethylenically unsaturated monomers. The degree of crystallinity of the polymer can vary. The polymer may, for example, be a semi-crystalline high density polyethylene or may be an elastomeric copolymer of ethylene and propylene. Carboxyl, anhydride, or imide functionalities may be incorporated into the polymer by polymerizing or copolymerizing functional monomers such as acrylic acid or maleic anhydride, or by modifying the polymer after polymerization, e.g., by grafting, by oxidation, or by forming ionomers. Examples include acid modified ethylene acrylate copolymers, anhydride modified ethylene vinyl acetate copolymers, anhydride modified polyethylene polymers, and anhydride modified polypropylene polymers. Such polymers and copolymers generally are commercially available. The polyolefin may include suitable additives to enhance bondability and/or may be combined with other materials including but not limited to bondable SANTOPRENE.

Other materials that can be employed include, but are not limited to, polyimides, polyurethanes, polyolefins, polystyrenes, polyesters, polycarbonates, polyketones, polyureas, polyacrylates, and polymethacrylates. Useful polyacrylates and polymethacrylates include polymers of acrylic acid, methyl acrylate, ethyl acrylate, acrylamide, methacrylic acid, methyl methacrylate, ethyl methacrylate, and the like.

The aforementioned polymers may also include one or more additives. Examples of useful additives in clued but are not limited to pigments, plasiticizers, tackifiers, fillers, electronically conductive materials, electrically insulating materials, stabilizers, antioxidants, lubricants, processing aids, impact modifiers, viscosity modifiers and combinations thereof.

It is also within the purview of the present disclosure to provide a conduit having two or more discrete layers. The two or more discrete layers may be concentrically disposed relative to one another. The conduit construction may have multiple layers of various thermoplastic material concentrically disposed relative to one another surrounded by an external jacket also composed of a suitable melt-processible thermoplastic material. Thus, it is also within the scope of this disclosure is the use of one or more wires 12, 14 and 16 in a given layer of a multilayer conduit configuration as shown in FIG. 1.

As disclosed herein, the construction of the conduit 10 may include at least one first inner layer 18 and a second outer layer 20 fixed together at an interface 22 by suitable bonding techniques. Suitable bonding techniques include, but are not limited to, co-extrusion, interposition of adhesive bond layers, mechanical fits and the like. It is contemplated that the first inner layer 18 may be a monowall construction as depicted in FIG. 1. Alternately, the first inner layer may be composed of multiple polymeric layers. Nonlimiting examples of multilayer constructions that can be employed as the inner layer 18 include U.S. Pat. Nos. 5,524,673 and 5,865,218 among others.

In the aspect shown in FIG. 1, the one or more bendable wires 12, 14 and 16, etc. are initially embedded in the second outer layer 20 by co-extrusion with the outer layer 20 over the inner layer 18. The wires 12, 14 and 16 initially have a generally linear or straight configuration extending along the length of the conduit 10. In addition, the wires 12, 14 and 16, etc. are circumferentially spaced about the second outer layer 20, with the illustrated equidistant-circumferential spacing being but one example.

As indicated previously, that the first inner layer 18 may include a plurality of layers. It is also contemplated that the second outer layer 20 may also constitute, within the scope of the present invention, an intermediate layer of a multilayer tube having one or more additional layers radially disposed outward from the second layer 20. Thus it is considered to be within the purview of the present disclosure to interpose wires 12, 14, 16, etc. between any of the layers in the multilayer constructs discussed previously.

It is contemplated that the wires 12, 14, 16, etc. will have a diameter suitable for integration into the structure of conduit 10. As used herein, the term “integration into the conduit structure” is taken to include positioning of one or more wires 12, 14, 16, etc. with minimal deflection of the inner fluid-contacting surface 28 and/or outer surface 29 due to interposition of the wires 12, 14, 16, etc. in the conduit. As depicted in the drawing figures, the wires 12, 14, 16, etc. can be integrated into layer 20. It is contemplated that wires 12, 14, 16 can be positioned in the layer 20 such that the polymeric material of second layer 20 surrounds the respective wires.

It is contemplated that the conduit 10 may have dimensions suitable for its end use application. By way of nonlimiting example, the conduit 10 may have an outer diameter up to 50 mm in automotive applications such as fuel and vapor return lines with outer diameters between 5 and 50 mm being typical. Other outer diameter dimensions are contemplated depending upon the use to which the conduit is to be employed.

It is contemplated that the conduit will have a total wall thickness suitable for the desired end use. Wall thicknesses between 1 millimeters and 3 millimeters are contemplated with thicknesses between 0.5 mm and 2.5 mm being typical. It is contemplated that the first layer 18 may have a thickness sufficient to provide attributes including, but not limited to, one or more of fluid impermeability, structural integrity, and the like. Layer thicknesses between 0.1 mm and 2.0 mm for the first layer 18 are contemplated. In configurations having first and second layers 18, 20, it is contemplated that the second layer 20 will have a thickness suitable to contain wires 12, 14, 16, etc. therein.

Wires 12, 14, 16, etc. may have any suitable gage or thickness suitable for integration into the desired polymeric layer while retaining suitable strength and bendability characteristics. For example, wires 12, 14, 16 may have a diameter between 100 thousandths of an inch and 220 thousandths of an inch, with thicknesses between 140 and 190 thousandths of an inch being typical

While the wire 12, 14, 16 is discussed as having a diameter and hence a circular cross section, it is contemplated that the wire may have any cross-sectional profile as desired or required. Nonlimiting examples of such profiles include squares, ovals, and the like capable of maintaining the desired bend profile. With such cross-sectional profiles, it is contemplated that the wire will have a dimensional maximum within the ranges discussed.

The wire may be composed of any suitable metal or metal alloy capable of being bent and retaining the bend configuration desired. Nonlimiting examples of suitable metals and metal alloys include nonferrous materials such as copper, aluminum, brass, and the like, as well as ferrous metal materials such as low carbon steel, stainless steel, and the like. Bendability can be expressed as a function of tensile strength. The wire material of choice may have a tensile strength between 80 psi to 180 psi. Thus one nonlimiting example is 19 guage copper wire.

In configurations here one or a plurality of wires are employed, it is contemplated that one or more wires 12, 14, 16, etc. can be configured to convey electric charge including charge in ranges including but not limited to electrostatic charge accumulated in the conduit 10. It is also contemplated that one or more wires 12, 14, 16 can be configured to carry or convey logic from one point to another. To this end, it is also contemplated that one or more wires 12, 14, 16 can be configured as fiber optic cable or the like. It is to be understood that the fiberoptic cable employed may lack the desired bend retention characteristics. Where this is the case, it is contemplated that the conduit 10 will include at least one wire 12 having suitable bend characteristics.

Where second layer 20 carries the one or more wires 12, 14 and 16, it is contemplated that the second layer will be composed of any suitable thermoplastic material capable of establishing a non-movable bond with the one or more wires 12, 14 and 16. Nonlimiting examples of suitable thermoplastic and elastomeric materials are those materials providing sufficient adhesion to fix the wires 12, 14 and 16 in place without associated longitudinal extension upon flexure. It is contemplated that the thermoplastic material employed in outer layer 20 can be a suitable melt processible material. Nonlimiting examples include thermoplastic elastomers and thermoplastic rubbers. It is believed that longitudinal extension in the polymeric material could stress and change the prebent shape of the wires 12, 14 and 16 and the overall conduit 10. Nonlimiting examples of suitable polymeric materials include thermoplastic elastomers of which SANTOPRENE is but one example. Without being bound to any theory, it is believed that thermoplastic elastomers exhibit sufficient adhesion with metal wires of the size and configuration disclosed herein to provide structural conformance between the wire 12, 14, 16 and the polymeric elements of the conduit 10 when a portion of the wire 12, 14, 16 is bent.

It is believed that location of wires 12, 14, 16, etc. in second layer 20 may provide a configuration whereby the inner layer 18, outer layer 20, and associated wires 12, 14, 16 interact to efficaciously transfer bending stresses in a manner that maintains and promotes the structure integrity of the conduit 10.

In use, once the conduit 10 has been formed with the embedded wires 12, 14 and 16 EK, the conduit 10 may be bent into a predetermined configuration, either by hand or by the use of shaping fixtures, mandrels, etc. The wires 12, 14 and 16 have sufficient springiness to assume and remain in the bent shape thereby holding the entire conduit 10 in the bent shape. The bends imparted may be single or multi-plane bends.

When used in a given application, it is contemplated that conduit 10 can be bent to fit on the job site before or during the installation process. It is also contemplated that a conduit 10 can be prototype fitted by a suitable method such as manual fitting process. The resulting bent conduit can be analyzed by suitable methods to produce digital drawings and/or suitable mass production solutions using various shaping fixtures, mandrels, and the like. Thus it is contemplated that the conduit 10 as disclosed herein may be present in its desired bent configuration having at least one bend imparted therein or in the generally linear prebent configuration. As used herein, the term “bend” is taken to mean a deviation from the linear plane defined by the longitudinal axis of the conduit 10. Thus the conduit 10, subsequent to bending and forming operations, will be one that includes at least one thermoplastic layer with at least one wire embedded therein. The conduit will be an elongated object having a first longitudinal axis and at least one bend or deviation in which the conduit devites from the first longitudinal axis in at least one plane. It is contemplated that the resulting finished conduit can have multiple deviations in one or more planes. The respective bends or deviations may be of any suitable angle or orientation capable of being impacted while maintaining the functionality of fluid transport cavity defined in the cavity.

In addition to retaining the conduit 10 in a desired bent or serpentine shape, it is contemplated that the wires 12, 14 and 16, etc. when deployed in a circumferentially spaced manner within the conduit 10, will also provide collapse resistance to the conduit 10 during the formation of the bend, particularly multi-plane bends or when the conduit 10 is subjected to an impact force.

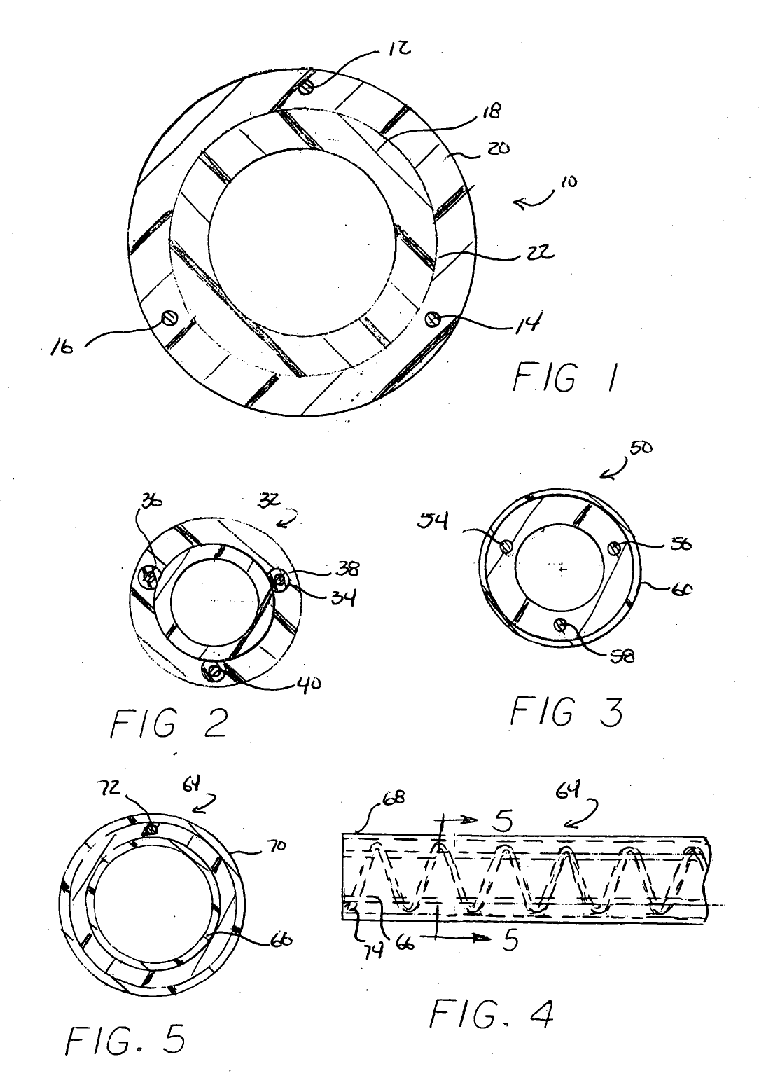

An alternate conduit configuration is depicted in FIG. 2 in which one or more wires are deployed in an inner layer 30 of a multilayer conduit 32. In this aspect, the inner layer 30 includes three radially outward extending enlargements 34 at circumferentially spaced locations. The enlargements each receive a spring wire 36, 38 and 40. An outer layer 42 of a suitable material, such as bondable melt-processible thermoplastic is joined over the inner layer 30. The wires 36, 38 and 40 may be co-extruded with the extrusion of the inner layer 30. The outer layer 42 may be co-extruded over the inner layer 30 and the enlargements 34 containing the wires 36, 38 and 40. It is contemplated that this alternate configuration as depicted in FIG. 2 can include any suitable number of end arguments 34 and associated wires and will include a minimum of one enlargement and wire configuration.

It is contemplated that the inner layer 30 may be composed of one or more melt-processible thermoplastic materials. Nonlimiting examples of suitable thermoplastic materials include those previously discussed in relation with the embodiment in FIG. 1, the outer layer 42 may be composed of suitable melt-processible thermoplastic materials capable of bonding with the inner layer 30, of which SANTOPRENE is one nonlimiting example.

In the embodiment as depicted in FIG. 2, the wires 36, 38, 40, etc are each encased in a layer of a suitable material capable of enhancing the bond or adhesion between the wire and associated inner layer 30. Suitable materials include melt-processible thermoplastics of which bondable SANTOPRENE is one nonlimiting example. The wires 36, 38, 40 may have the composition and dimension discussed previously in conjunction with FIG. 1. It is contemplated that each enlargement 34 may be composed of a wire enclosing layer and that each wire enclosing layer 37, 39, 41 will have a thickness sufficient to surround and encase the respective wire. Thus wires 36, 38, 40, etc. may have thicknesses between 100 thousandths and 220 thousands of an inch with thicknesses between 140 and 220 thousandths of an inch being typical. The thickness of the respective wire encasing layer can be between 50 thousandths and 200 thousandths of an inch, or as desired or required to form enlargements 34.

The wire encasing layer can be separately interposed into direct contact with the thermoplastic material of inner layer 30. Thus, where inner layer 30 and encasement layers 37, 39, 41, etc. are composed of the same or similar thermoplastic materials, the inner layer 30, when viewed in cross-section, will have a generally circular shape with outwardly projecting enlargements positioned thereon. One nonlimiting example, the wires 36, 38, 40, etc. are encased with a bondable thermoplastic elastomer such as bondable SANTOPRENE. The inner layer 30 is composed of a suitable melt-processible thermoplastic material such as SANTOPRENE such that the layer 30 and encasement form an essentially unitary layer. The outer layer 42 surrounds and encases the inner layer/encasement construct.

The wires 36, 38, 40, etc. may extend longitudinally along the body of conduit 32 in the manner discussed previously in connection with FIG. 1. Alternately, it is contemplated that wires 36, 38, 40, etc. can be oriented in a spiral manner relative to the longitudinal axis of conduit 32. The conduit 30 may be bent or shaped by any suitable means. As discussed previously in conjunction with FIG. 1, the finished conduit may have at least one bend imparted therein.

FIG. 3 depicts a modification to the conduit 32 shown in FIG. 2. In this aspect of the invention, a conduit 50 includes an inner layer 52 having one or more wires, such as wires 54, 56 and 58, by example, embedded therein. An outer layer 60, such as a bondable SANTOPRENE, may be formed over and bonded to the inner layer 52 by co-extrusion, or by use of an intermediate coextruded adhesive layer. The wires can be of the construction and configuration discussed previously in conjunction with FIG. 1. It is contemplated that the wires 54, 56, 58 will be encased in a suitable bondable thermoplastic material that itself bonds to the polymeric material of the inner layer 52. An outer layer 60 composed of a bondable thermoplastic may be formed over and bonded to the outer surface of the inner layer 52 in overlying relationship with the outer surface and wires 54, 56, 58. The bondable thermoplastic of the outer layer 60 may be the same or different from that employed to encase the wires 54, 56, 58. As depicted in FIG. 3, the outer layer 60 may have an essentially smooth outer surface. It is also contemplated that the outer layer can have a contoured surface such as one with ridge lines associated with the respective wire positions.

The one or more wires 54, 56 and 58 may also be provided in an initial, non-linear shape, such as a spiral or helical shape as shown in FIG. 4. In this aspect of the invention, a conduit 64 includes an inner layer 66 and one or more outer layers, with two outer layers 68 and 70 being illustrated by way of example only. It is contemplateds that wires 54, 56, 58, etc., can be composed of the materials discussed previously in conjunction with FIGS. 2 and 3 and similar cross-sectional configurations. The conduit 50 may be bent or shaped by any suitable means. The finished conduit may have at least one bend imparted therein.

A single wire shown in FIG. 5 is embedded in the layer 68 surrounding the inner layer 66. The wire 72 is illustrated as having an initial spiral or helical configuration along the length of the conduit 64. Conduit 64 may be bent or shaped yb any suitable means. As discussed previously in conjunction with FIG. 1, the finished conduit may have at least one bend imparted therein.

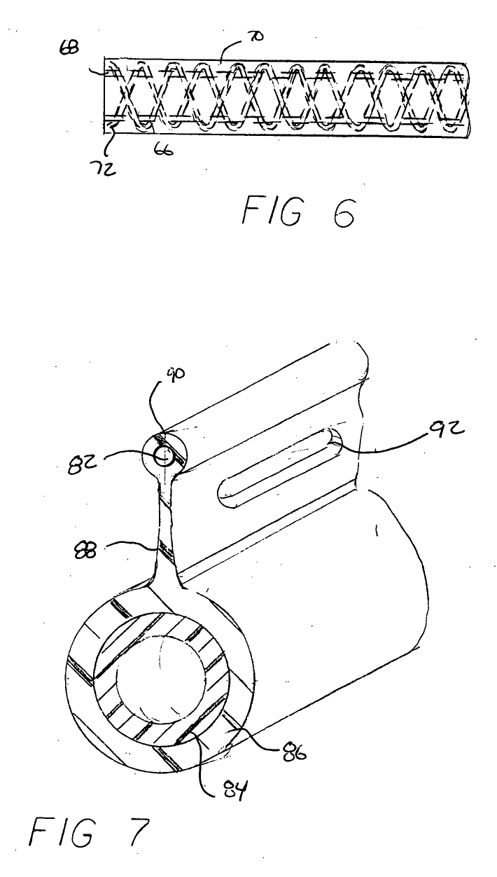

It is also possible within the scope of the present invention, as shown in FIG. 6, to provide the conduit 64 shown in FIGS. 4 and 5 with a second helically shaped wire 78 which is spirally offset and interwoven with the first wire 72 along the length of the conduit 64.

Referring now to FIG. 7, there is depicted a different configuration for a conduit 80 which may employ the bendable wire 82. In this aspect, the conduit 80 is formed with at lease one inner layer 84, such as a nylon or polymeric material, and an outer layer 86 bonded to the inner layer 84 by co-extrusion, adhesive, etc. It is contemplated that the inner layer 84 may be composed of multiple thermoplastic layers of the same or different materials as desired or required. The outer layer 86 may be formed of a suitable bondable thermoplastic material of which bondable SANTOPRENE is one nonlimiting example. The outer layer 86 comprises an essentially circular cross-sectional main body as with at least one web 88 projecting radially outward therefrom. The outer layer 86 is formed, such as by extrusion, with a thin web 88 projecting radially outward from a more circular cross-section portion of the outer layer 86. The web 88 transitions into an end portion 90 having a generally circular cross-section surrounding wire 82 which may be co-extruded therein.

The web 88 can be flexible enough to assume or conform to the shape formed in the wire 82 and thereby conform the main portion of the conduit 80 to the same bent shape. Apertures 92 may be formed as spaced locations along the length of the web 88 for receiving clips, pins or other fastening members, not shown, for mounting the conduit 80 to a surrounding support structure.

As indicated previously, any of the conduits 10, 32, 50, 64 and 80 described above, may employ at least one of the wires 12, 14, 16, etc. as an electrical power or signal conductor. Ends of any of the wires 12, 14, 16, etc., can be connected to terminals which are in turn conductively coupled to electric components, power supplies, sensors, etc., for conducting power or control signals along the conduit. The embedded wires 12, 14, 15, etc., can thus perform multiple or varied functions of maintaining the conduit in the desired bent shape without the use of thermal energy for conduit shaping and, at the same time, as an electrical signal or power conductor.

As part of an electricity carrying feature, the embedded wire or wires can also serve as a static charge dissipative conductor when the wires 12, 14, or 16, etc., are embedded in the innermost layer, such as the wires 36, 38, and 40, etc., embedded in the inner layer 30 in the conduit 32 shown in FIG. 2 or in electrical contact or embedded in an outer layer, but positioned in electrical contact with the inner layer, as shown in FIG. 1. If the inner layer 18 is formed of an electrically conductive plastic, any static charge generated by fluid, such as automotive fuel, flowing through the bore in the conduit 10, for example, will be carried by the wire or wires 12, 14, 16, etc., to a suitable ground termination connected at one end of the wire.

In summary, there has been disclosed a unique fluid conduit having one or more embedded wires which are shapable to a desired shape to retain the conduit in the same desired shape without the need for thermal energy to shape the conduit. One or more of the flexible wires can also be used as an electrical power, signal conductor or static charge conductor to transmit power, signals or electric charge, along the length of the conductor at the same time as providing the conduit shaping feature.

In general, the present invention is a fluid carrying component having at least one form retaining, shapable, lengthwise-extending wire embedded in the tube material which is connected as an electrical signal, electric power or electric charge carrying conductor by connecting ends of the at least one wire to electrical terminals or components.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A conduit comprising:
at least one first layer composed of at least one thermoplastic material; and
at least one wire bondably embedded in the first layer, the wire composed of at least one bendable material.

2. The conduit of claim 1 wherein the thermoplastic material in the first layer is at least one of thermoplastic elastomers, polyolefins, thermoplastic polyesters, polyamides, and polyphenylene sulfates.

3. The conduit of claim 1 wherein the bendable material of the wire is composed of at least one of ferrous metals, ferrous metal alloys, nonferrous metals, and nonferrous metal alloys.

4. The conduit of claim 1 further comprising at least one second layer disposed concentrically relative to the at least first layer, the second layer composed of at least one thermoplastic material.

5. The conduit of claim 5 wherein a plurality of wires are disposed at spaced intervals around the first layer.

6. The conduit of claim 4 wherein at least one wire is composed of at least one of ferrous metals, ferrous metal alloys, nonferrous metals, and nonferrous metal alloys.

7. The conduit of claim 6 wherein the plurality of wires extends longitudinally along the conduit.

8. The conduit of claim 4 wherein the first layer is disposed radially inward of the second layer.

9. The conduit of claim 4 wherein the first layer comprises at least one tubular body and at least one enlargement region in contact with one face of the tubular body, the enlargement region surrounding the wire and in bondable contact therewith.

10. The conduit of claim 9 wherein the enlargement member is composed of thermoplastic material selected from the group consisting of thermoplastic elastomers, thermoplastic polyesters, polyolefins, polyamides, and polyphenylene sulfate.

11. The conduit of claim 10 wherein the enlargement member is located on an exterior surface of the first layer.

12. The conduit of claim 11 further comprising an elongated web interposed between the enlargement member and the exterior surface of the first layer, the elongated web composed of a melt-processible thermoplastic material.

13. The conduit of claim 4 wherein the second layer comprises a plurality of thermoplastic layers concentrically disposed relative to one another.

14. The conduit of claim 1 wherein the conduit comprises at least one first region having a first longitudinal axis and at least one second region deviating from the first longitudinal axis in at least one plane.

15. A conduit comprising:
a first layer composed of a first thermoplastic material,
a second layer concentrically disposed relative to the first layer, the second layer composed of a second thermoplastic material;
at least one wire bondably embedded in the first layer such that the wire is surrounded by the first thermoplastic material, the wire composed of at least one bendable material selected from the group consisting of ferrous metals, ferrous metal alloys, nonferrous metals, nonferrous metal alloys and mixtures thereof, and wherein the thermoplastic material of the first layer is a bondable material selected from the group consisting of thermoplastic elastomers, polyolefins, thermoplastic polyesters, polyamides, and mixtures thereof.

16. The conduit of claim 15 wherein the thermoplastic material of the first layer is composed of at least one of thermoplastic elastomers, polyolefins, thermoplastic polyesters, polyamides, and polyphenylene sulfates, wherein the thermoplastic material bonds with the embedded wire.

17. The conduit of claim 16 wherein the conduit has a first region having a first longitudinal axis and at least one addition region deviating from the first longitudinal axis in at least one plane.

18. The conduit of claim 16 wherein a plurality of wires is disposed at spaced intervals around the first layer.

19. The conduit of claim 16 wherein the first layer comprises at least one tubular body and at least one enlargement region, the enlargement region surrounding the wire and in bondable contact therewith.
